(19) United States
(12) Patent Application Publication
(10) Pub. No.: US 2026/0129331 A1
(43) Pub. Date: May 7, 2026

(54) EARPHONES

(71) Applicant: SHENZHEN SHOKZ CO., LTD., Shenzhen (CN)

(72) Inventors: Chaowu LI, Shenzhen (CN); Qianwen NIE, Shenzhen (CN); Jianing LIANG, Shenzhen (CN)

(73) Assignee: SHENZHEN SHOKZ CO., LTD., Shenzhen (CN)

(21) Appl. No.: 19/435,725

(22) Filed: Dec. 29, 2025

Related U.S. Application Data
(63) Continuation of application No. PCT/CN2024/114010, filed on Aug. 22, 2024.

(51) Int. Cl. H04R 1/10

(52) U.S. Cl. CPC H04R 1/1016; H04R 1/105

(57) ABSTRACT

The present disclosure relates to an earphone. The earphone includes: a core housing, a speaker assembly and a button assembly disposed in the core housing. The speaker assembly includes a main speaker and an acoustic cavity bracket, the acoustic cavity bracket cooperates with the main speaker to form an acoustic rear cavity, the button assembly is supported by the acoustic cavity bracket, and the core housing is provided with a button portion for pressing to trigger the button assembly.

### TECHNICAL FIELD

The present disclosure relates to the field of electronic devices, in particular, to earphones.

### BACKGROUND

With the continuous popularization of electronic devices, electronic devices have become indispensable social and entertainment tools in people's daily lives. People have increasingly higher requirements for electronic devices. Electronic devices such as earphones and smart glasses have been widely used in people's daily lives. These electronic devices can be used in conjunction with terminal devices such as mobile phones and computers to provide users with an auditory feast.

Traditional earphones usually include buttons for users to press and control the earphones. However, the arrangement of the buttons and structures related to the buttons may cause the earphones to have a relatively large size.

### SUMMARY

To solve the above technical problem, one technical solution adopted in the present disclosure is to provide an earphone. The earphone includes a core housing, a speaker assembly and a button assembly disposed in the core housing. The speaker assembly includes a main speaker and an acoustic cavity bracket. The acoustic cavity bracket cooperates with the main speaker to form an acoustic rear cavity. The button assembly is supported by the acoustic cavity bracket. The core housing is provided with a button portion for pressing to trigger the button assembly.

In some embodiments, the earphone further includes a main control circuit board. The main control circuit board is stacked with the speaker assembly along a vibration direction of the main speaker. A main surface of the main control circuit board is arranged to face toward or away from the speaker assembly. The acoustic cavity bracket is arranged around the main speaker. The button assembly is supported by an outer circumferential surface of the acoustic cavity bracket and is electrically connected to the main control circuit board.

In some embodiments, the button assembly includes a support plate and a button body disposed on a side of the support plate away from the acoustic cavity bracket. The button body is fixedly connected to the support plate. The support plate is fixedly supported by the outer circumferential surface of the acoustic cavity bracket. An angle between a main surface of the support plate away from the acoustic cavity bracket and an axial direction of the acoustic cavity bracket is in a range of 0° to 10°.

In some embodiments, the main surface of the support plate away from the acoustic cavity bracket is arranged perpendicular to the main surface of the main control circuit board facing toward or away from the speaker assembly, or an angle between the main surface of the support plate and the main surface of the main control circuit board is in a range of 80° to 90°.

In some embodiments, a supporting surface is provided on the outer circumferential surface of the acoustic cavity bracket. A side of the support plate facing toward the acoustic cavity bracket is supported by the supporting surface. A limiting mechanism for limiting the support plate is further provided on the acoustic cavity bracket.

In some embodiments, the limiting mechanism includes a first limiting part disposed on a side of the supporting surface away from the main control circuit board. The first limiting part is configured to limit the support plate in a first direction. The first direction is a direction parallel to the supporting surface and away from the main control circuit board.

In some embodiments, a pressing block is disposed between the main control circuit board and the support plate. The pressing block is configured to elastically abut against a first plate edge of the support plate facing toward the main control circuit board, so that a second plate edge of the support plate away from the main control circuit board is supported by the first limiting part.

In some embodiments, the limiting mechanism includes a second limiting part. The second limiting part is disposed around the supporting surface along a second direction. The second direction is parallel to the supporting surface and perpendicular to the first direction. The second limiting part is configured to limit the support plate in the second direction.

In some embodiments, the limiting mechanism includes two second limiting parts. The two second limiting parts are arranged at intervals along the second direction. The support plate is located between the two second limiting parts. Or the support plate includes a main body portion and a hook-shaped portion connected to the main body portion. The main body portion is supported by the supporting surface. The hook-shaped portion is hooked on a side of the second limiting part away from the supporting surface.

In some embodiments, the limiting mechanism includes a third limiting part arranged perpendicular to the supporting surface and spaced apart from the supporting surface. The third limiting part is located on a side of the supporting surface that supports the support plate. The third limiting part is configured to limit the support plate in a vertical direction of the supporting surface.

In some embodiments, a button hole is formed in the core housing. The button portion includes a cantilever beam, a button cap, and a soft filler. The cantilever beam, the soft filler, and the button cap are disposed in the button hole. The cantilever beam is integrally formed with the core housing. A fixed end of the cantilever beam is located at a hole edge of the button hole. The button cap is disposed at a free end of the cantilever beam. The soft filler is configured to fill a gap between an assembly of the cantilever beam and the button cap, and the hole edge of the button hole.

In some embodiments, the earphone further includes an ear hook. The core housing has a connection end connected to the ear hook and a free end away from the connection end. In a wearing state, the ear hook is hooked between an auricle and the head of a user. The core housing is located at a front side of the auricle. The free end at least partially covers or extends into a cavum conchae. The core housing has a longitudinal direction, a thickness direction, and a width direction orthogonal to each other. The longitudinal direction is a separation direction between the connection end and the free end. The thickness direction is a direction toward or away from the auricle in the wearing state. The core housing includes a first side wall and a second side wall arranged along the width direction. The button portion is disposed on the first side wall or the second side wall.

In some embodiments, the earphone further includes an ear hook and a magnet assembly. The core housing has a connection end connected to the ear hook and a free end away from the connection end, and a polarization direction of the magnet assembly is the same as a polarization direction of a main magnet of the main speaker. The speaker assembly further includes an auxiliary speaker. The magnet assembly and the auxiliary speaker are disposed along the vibration direction of the main speaker on a side of the main speaker close to an auricle of a user in a wearing state, and when viewed along a longitudinal direction of the core housing, the magnet assembly and the auxiliary speaker at least partially overlap. The longitudinal direction is a separation direction between the connection end and the free end.

In some embodiments, a ratio of a projection area of the magnet assembly along a thickness direction of the core housing to a projection area of the main magnet of the main speaker along the thickness direction is in a range of 0.1 to 0.2. The thickness direction of the core housing is a direction of the core housing toward or away from the auricle of the user in the wearing state, and the thickness direction and the longitudinal direction are orthogonal to each other.

In some embodiments, the vibration direction of the main speaker and the longitudinal direction define a symmetry plane. The magnet assembly includes two magnets, and the two magnets are located on two sides of the symmetry plane and are symmetrically arranged relative to the symmetry plane.

Beneficial effects of the present disclosure are as follows. The earphone described in the present disclosure is provided with the main speaker, the acoustic cavity bracket, and the button assembly. The acoustic cavity bracket can cooperate with the main speaker to form the acoustic rear cavity, thereby ensuring a sound pickup effect of the main speaker. Meanwhile, the acoustic cavity bracket can support the button assembly. Therefore, functional reuse of the acoustic cavity bracket can be achieved. Furthermore, there is no need to additionally provide a support component to support and fix the button assembly. Consequently, space inside the earphone can be saved, the size of the earphone can be reduced, and space utilization can be improved.

### BRIEF DESCRIPTION OF THE DRAWINGS

FIG. 1 is a schematic diagram illustrating an exemplary anterior contour of an ear of a user according to some embodiments of the present disclosure;

FIG. 2 is a schematic diagram illustrating an exemplary three-dimensional structure of one side of an earphone according to some embodiments of the present disclosure;

FIG. 3 is a schematic diagram illustrating the earphone of FIG. 2 in a wearing state according to some embodiments of the present disclosure;

FIG. 4 is a schematic diagram illustrating a first exploded structural view of a sound generating portion in the earphone of FIG. 2 according to some embodiments of the present disclosure;

FIG. 5 is a schematic diagram illustrating a second exploded structural view of the sound generating portion in the earphone of FIG. 2 according to some embodiments of the present disclosure;

FIG. 6 is a schematic diagram illustrating an exemplary cross-sectional structure of the earphone of FIG. 2 taken along section line A-A according to some embodiments of the present disclosure;

FIG. 7 is an enlarged schematic diagram illustrating a local region I of the sound generating portion of FIG. 4 according to some embodiments of the present disclosure;

FIG. 8 is an enlarged schematic diagram illustrating a local region J of the sound generating portion of FIG. 6 according to some embodiments of the present disclosure;

FIG. 9 is a schematic diagram illustrating a third exploded structural view of the sound generating portion in the earphone of FIG. 2 according to some embodiments of the present disclosure;

FIG. 10 is a schematic diagram illustrating an exemplary structure of some components in the sound generating portion of FIG. 9 from a first perspective view according to some embodiments of the present disclosure; and

FIG. 11 is a schematic diagram illustrating an exemplary structure of some components in the sound generating portion of FIG. 9 from a second perspective view according to some embodiments of the present disclosure.

### DETAILED DESCRIPTION

In order to more clearly illustrate the technical solutions in the embodiments of the present disclosure, the drawings used in the description of the embodiments will be briefly introduced below. It is obvious that the drawings in the following description are only some embodiments of the present disclosure. All other embodiments obtained by a person of ordinary skill in the art based on the embodiments of the present disclosure, without creative efforts, shall fall within the protection scope of the present disclosure.

The term “embodiment” as used in the present disclosure means that a particular feature, structure, or characteristic described in connection with the embodiment may be included in at least one embodiment of the present disclosure. A person skilled in the art explicitly and implicitly understands that the embodiments described in the present disclosure may be combined with other embodiments.

The following provides an exemplary description of an earphone in an earphone embodiment.

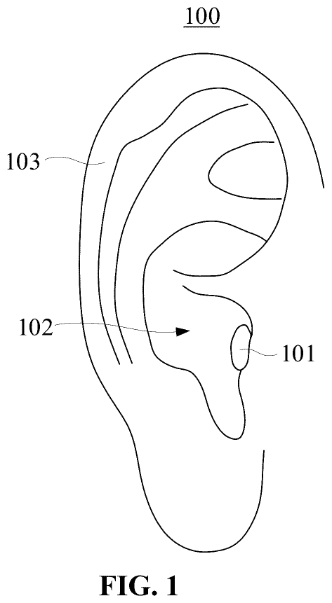

With reference to FIG. 1, an ear 100 of a user may include physiological parts such as an ear canal 101, a cavum conchae 102, and an auricle 103. Although the ear canal 101 has a certain depth and extends to an eardrum of the ear 100, for ease of description, the ear canal 101 in the present disclosure specifically refers to an entrance (i.e., an ear hole) away from the eardrum, unless otherwise specified. In addition, the cavum conchae 102 has a certain volume and depth, and the cavum conchae 102 is in direct communication with the ear canal 101. That is, the ear hole may be simply considered to be located at a bottom of the cavum conchae 102.

An earphone 1 is an audio converter. The earphone 1 is configured to receive an electrical signal from a media player or a receiver and convert the electrical signal into a sound wave that can be heard by a user. In some embodiments, the earphone 1 may be an open earphone, for example, an ear hook earphone, a behind-the-neck earphone, or an ear clip earphone.

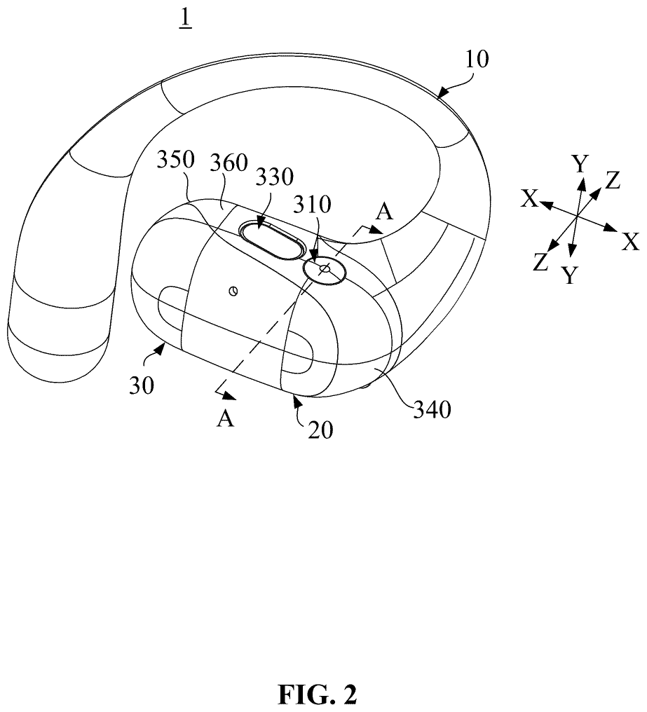

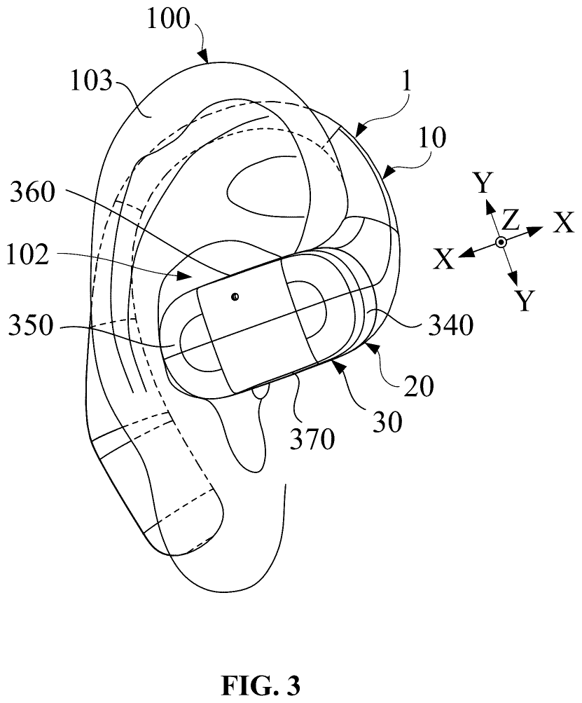

As shown in FIG. 2 or FIG. 3, the earphone 1 may be the ear hook earphone. In some embodiments, in a wearing state, at least a portion of the earphone 1 may be inserted into the cavum conchae 102 of a user to improve wearing stability. In some embodiments, a sound generating portion of the earphone 1 may at least partially cover an auricle of the user's ear, for example, an antihelix, a cymba conchae, or a triangular fossa, but does not block the ear canal 101 of the user's ear or visually block the ear canal 101 of the user's ear. In some embodiments, a sound generating portion 20 of the earphone 1 may also fit against or abut a facial region in front of the user's ear. A side of the sound generating portion 20 for generating sound faces the user's ear or faces the ear canal 101 of the user.

Further, different users may have individual differences, resulting in dimensional differences such as different shapes and sizes of the ear 100. For ease of description and to reduce or even eliminate individual differences of different users, a simulator including a head and ears 100 (left and right) may be manufactured based on ANSI: S3.36, S3.25 and IEC: 60318-7 standards, for example, GRAS 45BC KEMAR, HEAD Acoustics, B&K 4128 series, or B&K 5128 series, to present a scenario in which most users wear the earphone 1. Merely by way of example, using GRAS KEMAR as an example, the simulator for the ear 100 may be any one of GRAS 45AC, GRAS 45BC, GRAS 45CC, or GRAS 43AG. As another example, using HEAD Acoustics as an example, the simulator for the ear 100 may be any one of HMS II.3, HMS II.3 LN, or HMS II.3LN HEC. Therefore, in the present disclosure, descriptions such as “a user wears the earphone 1”, “the earphone 1 is in a wearing state”, and “in a wearing state” may mean that the earphone 1 described in the present disclosure is worn on the ear 100 of the simulator. Certainly, precisely because different users have individual differences, there may be some differences when the earphone 1 is worn by different users compared to when the earphone 1 is worn on the ear 100 of the simulator. However, such differences should be tolerated.

Merely by way of example, with reference to FIG. 2 and FIG. 3, the earphone 1 may include an ear hook 10 and the sound generating portion 20 that are connected to each other. In the wearing state, the ear hook 10 may be hung between the auricle 103 and the head of the user. That is, at least a portion of the ear hook 10 of the earphone 1 may be located at a rear side of the ear 100, so that the earphone 1 is hung on the ear 100. The sound generating portion 20 may be located at a front side of the auricle 103.

The sound generating portion 20 may be a sound playback device. The sound generating portion 20 may be configured to convert the electrical signal into a sound signal and propagate the sound signal to the ear 100 of a wearer.

In some embodiments, a battery and/or a circuit board may be disposed in the ear hook 10. Certainly, the ear hook 10 may not be provided with the battery and/or the circuit board, and the battery and/or the circuit board may be installed in the sound generating portion 20.

Merely by way of example, in the earphone 1, the ear hook 10 may be replaced by other structures that can achieve wearing on the user's head, for example, a ribbon, a clip, a ring structure, a hat, a bracket, or a U-shaped structure, to achieve wearing of the sound generating portion 20. Certainly, in some embodiments, the ear hook 10 may be omitted.

In some embodiments, as shown in FIG. 2 to FIG. 5, the earphone 1 may include a core housing 30, a speaker assembly 40, and a button assembly 50. The speaker assembly 40 and the button assembly 50 are disposed in the core housing 30. The speaker assembly 40 and the button assembly 50 may be cooperatively installed together in the core housing 30 to save space inside the core housing 30, reduce a size of the core housing 30, and improve space utilization.

Merely by way of example, the core housing 30, the speaker assembly 40, and the button assembly 50 may be disposed in the sound generating portion 20. The speaker assembly 40 refers to a component configured to convert the electrical signal into a corresponding sound signal, so that the sound generating portion 20 has a sound playback function. In some embodiments, the speaker assembly 40 may include a bone conduction speaker and an air conduction speaker. In some embodiments, the speaker assembly 40 may also be set as one of the air conduction speaker and the bone conduction speaker.

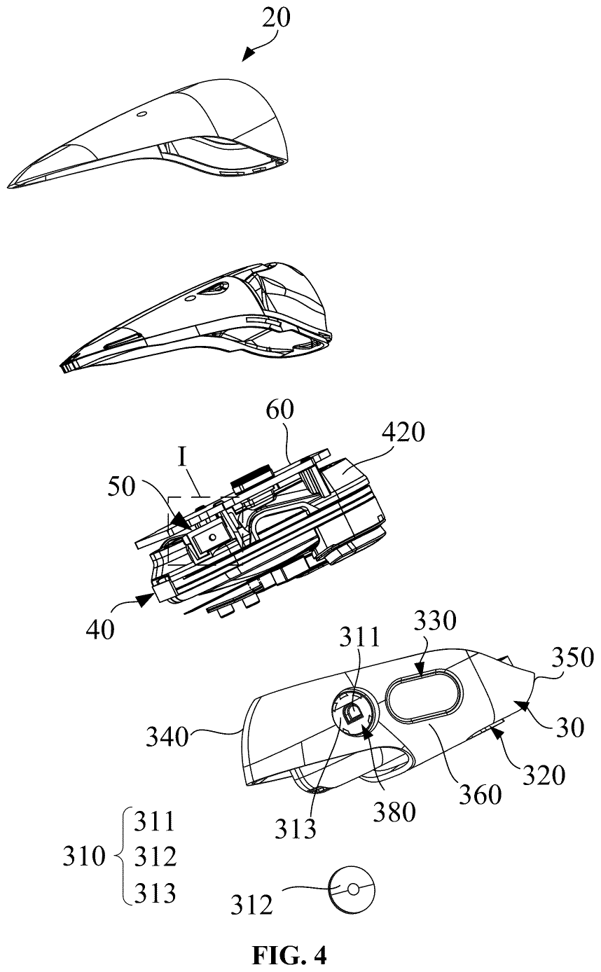

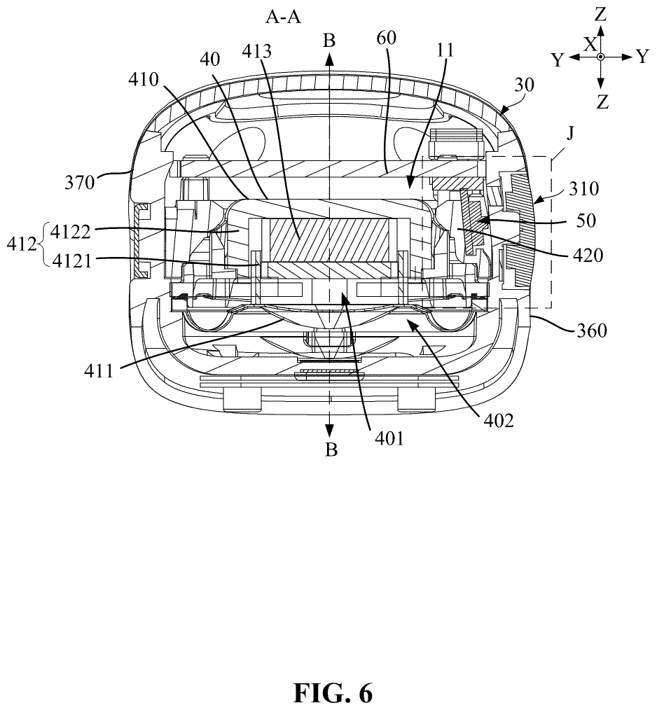

In some embodiments, as shown in FIG. 4 and FIG. 6, the speaker assembly 40 may include a main speaker 410 and an acoustic cavity bracket 420. The acoustic cavity bracket 420 may cooperate with the main speaker 410 to form an acoustic rear cavity 401. The button assembly 50 is supported by the acoustic cavity bracket 420. With such a configuration, the acoustic cavity bracket 420 may cooperate with the main speaker 410 to form the acoustic rear cavity 401 and also support and fix the button assembly 50, thereby achieving functional reuse. Moreover, there is no need to additionally provide a support component inside the core housing 30 to support and fix the button assembly 50, thereby saving space inside the earphone 1, reducing the size of the earphone 1, and improving space utilization.

In some embodiments, a button portion 310 is disposed on the core housing 30 for pressing to trigger the button assembly 50. The button portion 310 may be disposed corresponding to the button assembly 50.

Merely by way of example, the button portion 310 may be disposed on the core housing 30. A portion of the button portion 310 may be exposed on an outer surface of the core housing 30 for the user to press to trigger the button assembly 50.

In some embodiments, the button assembly 50 may be connected to other structures in the earphone 1. Specifically, after the button portion 310 triggers the button assembly 50, the button assembly 50 may generate a corresponding control signal. The earphone 1 may perform a corresponding action in response to the control signal. In some embodiments, the control signal generated by the button assembly 50 may be a switch signal, a volume control signal, or a song switching signal for controlling the speaker assembly 40, so that the earphone 1 can implement functions such as turning on or off, volume adjustment, or song switching.

In some embodiments, the main speaker 410 may be the air conduction speaker. As shown in FIG. 6, the main speaker 410 may include a diaphragm 411 and a driving mechanism 412. The driving mechanism 412 may be connected to the diaphragm 411. The diaphragm 411, the driving mechanism 412, the acoustic cavity bracket 420, and the core housing 30 may together form the acoustic rear cavity 401. The diaphragm 411 and the core housing 30 may together form an acoustic front cavity 402. That is, the acoustic rear cavity 401 and the acoustic front cavity 402 are located on opposite sides of the diaphragm 411.

In some embodiments, the driving mechanism 412 may include a coil 4121 and a magnetic circuit system 4122. The magnetic circuit system 4122 is connected to the diaphragm 411. The diaphragm 411, the magnetic circuit system 4122, the acoustic cavity bracket 420, and the core housing 30 may together form the acoustic rear cavity 401. The coil 4121 and the magnetic circuit system 4122 may be configured to generate electromagnetic induction under control of the electrical signal, thereby driving the diaphragm 411 to vibrate, so that air in the acoustic front cavity 402 of the main speaker 410 vibrates to generate the sound wave, which is transmitted out of the earphone 1.

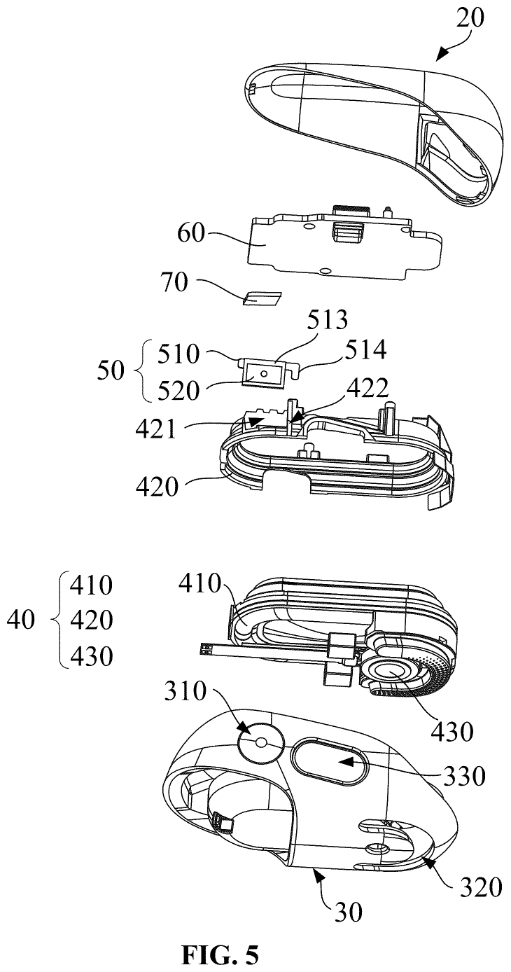

As shown in FIG. 4 and FIG. 5, a sound outlet hole 320 and a pressure relief hole 330 may be further provided on the core housing 30. The sound outlet hole 320 may be in communication with the acoustic front cavity 402. The pressure relief hole 330 may be in communication with the acoustic rear cavity 401. The sound wave generated on a front side of the diaphragm 411 is transmitted to the outside through the sound outlet hole 320. Air in the acoustic rear cavity 401 can be effectively conducted to the outside through the pressure relief hole 330, thereby preventing pressure buildup in the acoustic rear cavity 401 from affecting the sound quality of the main speaker 410.

In some embodiments, as shown in FIG. 2 and FIG. 3, the core housing 30 may have a connection end 340 connected to the ear hook 10 and a free end 350 away from the connection end 340. Merely by way of example, in the wearing state, the ear hook 10 is hung between the auricle 103 and the head of the user. The core housing 30 is located at the front side of the auricle 103. The free end 350 at least partially covers or extends into the cavum conchae 102.

In some embodiments, the core housing 30 has a longitudinal direction, a thickness direction, and a width direction that are orthogonal to each other.

In some embodiments, the longitudinal direction is a separation direction between the connection end 340 and the free end 350. The separation direction between the connection end 340 and the free end 350 refers to a direction indicated by a line segment connecting the connection end 340 and the free end 350. In some embodiments, the connection end 340 and the free end 350 are irregular or regular arc-shaped. An extension direction of a line connecting the connection end 340 and the free end 350 refers to a direction defined by a straight line perpendicular to parallel tangent planes of two reference points, which are farthest apart from each other, on the connection end 340 and the free end 350. The longitudinal direction is also defined as a direction the core housing 30 toward or away from the back of the head in the wearing state. In other words, the longitudinal direction may be a direction indicated by an arrow X in FIG. 2 and FIG. 3.

In some embodiments, the width direction is defined as a direction the core housing 30 toward or away from the top of the head in the wearing state. The width direction may be a direction indicated by an arrow Y in FIG. 2 and FIG. 3.

In some embodiments, the thickness direction of the core housing 30 is a direction toward or away from the auricle 103 in the wearing state. The thickness direction may be a direction indicated by an arrow Z in FIG. 2 and FIG. 3. In some embodiments, the thickness direction Z is substantially parallel to a vibration direction of the main speaker 410. Substantially parallel refers to a spatial angle between the two directions that is less than 5 degrees.

In some embodiments, as shown in FIG. 2 and FIG. 3, the core housing 30 includes a first side wall 360 and a second side wall 370 arranged along the width direction Y. The button portion 310 is disposed on the first side wall 360 or the second side wall 370. The button portion 310 is configured to be pressed by the user to trigger the button assembly 50. If the button portion 310 is disposed on a side away from the auricle 103 or on an edge of the core housing 30, pressing the button portion 310 may cause the core housing 30 to move, making the button portion 310 on the core housing 30 less susceptible to force triggering and affecting the stability and comfort of wearing the earphone 1. When the button portion 310 is disposed on the first side wall 360 or the second side wall 370, the user uses two fingers to simultaneously press the first side wall 360 and the second side wall 370. One finger triggers the button portion 310, and the other finger provides support on the opposite side wall. This facilitates the successful pressing of the button portion 310 and ensures that the earphone 1 does not shake in the wearing state, improving the user experience.

In some other embodiments, a plurality of button portions 310 are provided. A plurality of button assemblies 50 are also provided and correspond one-to-one with the button portions 310. For example, two button portions 310 are provided. The two button portions 310 are disposed on the first side wall 360 and the second side wall 370, respectively. Two button assemblies 50 are also provided. The two button assemblies 50 correspond one-to-one with the two button portions 310.

In some embodiments, as shown in FIG. 4 to FIG. 7, the earphone 1 further includes a main control circuit board 60 disposed in the core housing 30. The main control circuit board 60 is stacked with the speaker assembly 40 along the vibration direction of the main speaker 410. A main surface of the main control circuit board 60 faces toward or away from the speaker assembly 40. The acoustic cavity bracket 420 may surround the main speaker 410. The button assembly 50 is supported by an outer circumferential surface of the acoustic cavity bracket 420 and is electrically connected to the main control circuit board 60.

The main control circuit board 60 refers to a control core part inside the earphone 1. The main control circuit board 60 may be a circuit board such as a Printed Circuit Board (PCB) or a Flexible Printed Circuit board (FPC). The main surface of the main control circuit board 60 refers to a working surface for mounting components such as chips and connecting wires.

In some embodiments, the button assembly 50 is electrically connected to the circuit on the main surface of the main control circuit board 60 via a wire. In some other embodiments, the button assembly 50 is electrically connected to the main control circuit board 60 via an electrical connection member such as a flexible circuit board or an auxiliary PCB circuit board.

In some embodiments, the main surface of the main control circuit board 60 is perpendicular or substantially perpendicular to an axial direction of the main speaker 410. Substantially perpendicular refers that a spatial angle between the two directions is between 75° and 105°.

In some embodiments, the vibration direction of the main speaker 410 is the axial direction of the main speaker 410. The main control circuit board 60 may be stacked with the main speaker 410 along the axial direction of the main speaker 410. The acoustic cavity bracket 420 may surround the main speaker 410 along a radial direction of the main speaker 410. Therefore, the acoustic cavity bracket 420 and the main control circuit board 60 are also spaced apart along the axial direction of the main speaker 410.

In some embodiments, as shown in FIG. 6, the vibration direction of the main speaker 410 is the thickness direction Z of the core housing 30. That is, the acoustic cavity bracket 420 and the main control circuit board 60 are stacked and spaced apart from each other in the thickness direction Z of the earphone 1 to form an interval space 11. Since the current generated on the main control circuit board 60 may interact with the main speaker 410, thereby leading to poor sound quality of the main speaker 410, the interval space 11 is provided between the acoustic cavity bracket 420 and the main control circuit board 60 in the thickness direction Z of the earphone 1. This reduces the influence of the current of the main control circuit board 60 on the main speaker 410, thereby reducing a background noise of the main speaker 410 and ensuring the sound quality of the main speaker 410.

In some embodiments, as shown in FIG. 6 to FIG. 8, the button assembly 50 is supported by the outer circumferential surface of the acoustic cavity bracket 420 and partially extends into the interval space 11 along the thickness direction Z. Therefore, in a direction perpendicular to the thickness direction Z, a part of the button assembly 50 overlaps with the interval space 11 and another part of the button assembly 50 overlaps with the acoustic cavity bracket 420. Therefore, no additional installation space for the button assembly 50 is required in the thickness direction Z. In other words, the installation space of the button assembly 50 can reuse the interval space 11, thereby reducing the size of the core housing 30 in the thickness direction Z and improving the space utilization inside the core housing 30.

In some embodiments, the axial direction of the acoustic cavity bracket 420 is parallel or substantially parallel to the axial direction of the main speaker 410. Substantially parallel refers to a spatial angle between the two directions that is in a range of 0° to 5°. This arrangement makes structures of the acoustic cavity bracket 420, the main speaker 410, and the main control circuit board 60 more compact and further improves the space utilization of the core housing 30.

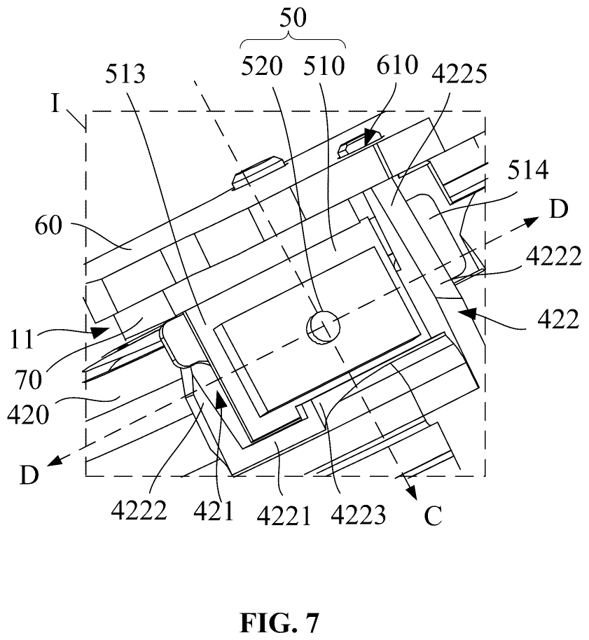

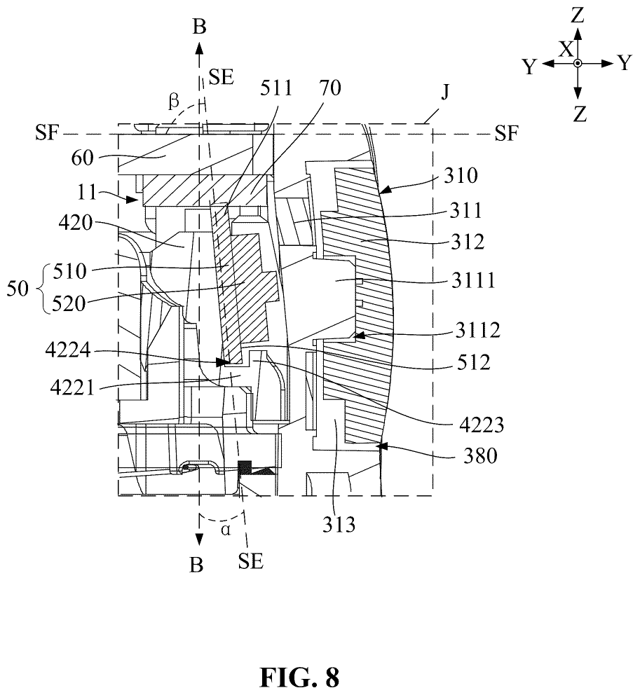

In some embodiments, as shown in FIG. 5, FIG. 7, and FIG. 8, the button assembly 50 includes a support plate 510 and a button body 520 disposed on a side of the support plate 510 away from the acoustic cavity bracket 420. The button body 520 is fixedly connected to the support plate 510. The support plate 510 is supported by the outer circumferential surface of the acoustic cavity bracket 420. An angle between the main surface of the support plate 510 away from the acoustic cavity bracket 420, and the axial direction of the acoustic cavity bracket 420 is in a range of 0° to 10°.

The main surface of the support plate 510 refers to a surface of the support plate 510 for mounting the button body 520. In some embodiments, the support plate 510 may be plate-shaped. The main surface of the support plate 510 is a side surface with the largest area. In some embodiments, the support plate 510 may be a support structure with a stepped surface. At least a part of the main surface is planar. In some embodiments, the support plate 510 may be a support structure that is overall arc-shaped and the main surface may be planar. The support plate 510 may extend in a direction of a plane where the main surface of the support plate 510 is located. This arrangement makes the structure of the support plate 510 more adaptable to the shape of the acoustic cavity bracket 420, thereby increasing the space utilization of the core housing 30.

The axial direction of the acoustic cavity bracket 420 may be indicated by an arrow B in FIG. 6 and FIG. 8. A plane where the main surface of the support plate 510 is located away from the acoustic cavity bracket 420 is indicated by a plane SE in FIG. 8. An angle between the main surface of the support plate 510 away from the acoustic cavity bracket 420 and the axial direction of the acoustic cavity bracket 420 is indicated by an angle α in FIG. 8, where 0°≤α≤10°.

If the angle between the main surface of the support plate 510 away from the acoustic cavity bracket 420 and the axial direction of the acoustic cavity bracket 420 is greater than 10°, the support plate 510 is tilted to a large degree relative to the axial direction of the acoustic cavity bracket 420, result in that the support plate 510 occupies a large space and a size of the core housing 30 in the width direction Y increases. Moreover, an overly tilted arrangement of the support plate 510 relative to the acoustic cavity bracket 420 makes it difficult to install the support plate 510 on the outer circumferential surface of the acoustic cavity bracket 420, thereby increasing the installation difficulty of the support plate 510 on the acoustic cavity bracket 420.

Therefore, setting the angle α in the range of 0° to 10° makes the main surface of the support plate 510 away from the acoustic cavity bracket 420 parallel or nearly parallel to the axial direction of the acoustic cavity bracket 420, thereby reducing space occupied by the support plate 510 in the axial direction of the acoustic cavity bracket 420, improving the space utilization. This also facilitates the installation of the support plate 510 on the outer circumferential surface of the acoustic cavity bracket 420.

In some embodiments, the main surface of the support plate 510 away from the acoustic cavity bracket 420 is arranged perpendicular to the main surface of the main control circuit board 60 facing toward or away from the speaker assembly 40, or an angle between the main surface of the support plate 510 and the main surface of the main control circuit board 60 is in a range of 80° to 90°.

Merely by way of example, the main surface of the main control circuit board 60 is indicated by a plane SF in FIG. 8. The angle between the main surface of the support plate 510 and the main surface of the main control circuit board 60 is indicated by an angle β in FIG. 8, where 80°≤β≤90°. For example, the angle β is 80°, 83°, 85°, 88°, or 90°.

If the angle β is less than 80° or greater than 90°, the support plate 510 is tilted to a large degree relative to the main control circuit board 60, result in that the support plate 510 occupies a large space in a direction parallel to the main surface of the main control circuit board 60, thereby increasing a size of the core housing 30 in such direction. When the angle β is equal to 90°, the main surface of the support plate 510 is perpendicular to the main surface of the main control circuit board 60.

Therefore, setting the angle between the main surface of the support plate 510 and the main surface of the main control circuit board 60 in the range of 80° to 90° allows the main surface of the support plate 510 to be perpendicular or nearly perpendicular to the main surface of the main control circuit board 60. This arrangement reduces the space occupied by the support plate 510 in the direction parallel to the main surface of the main control circuit board 60, thereby improving space utilization. In some embodiments, both the support plate 510 and the main control circuit board 60 may have a plate-like design. Therefore, the support plate 510 and the main control circuit board 60 may also be arranged to be perpendicular or nearly perpendicular to each other.

In some embodiments, as shown in FIG. 5 and FIG. 7, a supporting surface 421 may be provided on the outer circumferential surface of the acoustic cavity bracket 420. A side of the support plate 510 facing toward the acoustic cavity bracket 420 is supported by the supporting surface 421. A limiting mechanism 422 for limiting the support plate 510 may be further provided on the acoustic cavity bracket 420.

Merely by way of example, the provision of the supporting surface 421 facilitates better support of the support plate 510 on the acoustic cavity bracket 420. The limiting mechanism 422 may be provided on the supporting surface 421 or around the supporting surface 421 to limit the support plate 510, thereby preventing movement of the support plate 510 and the button assembly 50 as much as possible. This improves the structural stability of earphone 1 and can help avoid poor triggering of the button assembly 50.

In some other embodiments, an adhesive medium may be directly added between the main surface of the support plate 510 and the supporting surface 421. The adhesive medium is used to bond the support plate 510 and the supporting surface 421, thereby fixing and limiting the button assembly 50 on the supporting surface 421 without the need to provide the limiting mechanism 422. The adhesive medium may be glue, double-sided tape, or other substances with a certain adhesive force.

Alternatively, in other embodiments, the main surface of the support plate 510 and the supporting surface 421 may also be fixed to each other by welding, snap-fitting, screwing, etc., which will not be exhaustively enumerated in this embodiment.

In some embodiments, as shown in FIG. 7 and FIG. 8, the limiting mechanism 422 may include a first limiting part 4221 disposed on a side of the supporting surface 421 away from the main control circuit board 60. The first limiting part 4221 may be configured to limit the support plate 510 in a first direction. The first direction is a direction parallel to the supporting surface 421 and away from the main control circuit board 60. The first direction C may be parallel to the thickness direction Z of the core housing 30. The first limiting part 4221 limits a side of the support plate 510 away from the main control circuit board 60 in a direction parallel to the thickness direction Z. Alternatively, the first direction C may also be another direction inclined relative to the thickness direction Z, for example, a direction having a certain angle with the axis of the main speaker 410. Such an angle may correspond to the angle α formed by the support plate 510 and the axial direction of the acoustic cavity bracket 420. Merely by way of example, the first direction is shown by arrow C in FIG. 7.

In some embodiments, the first limiting part 4221 may protrude relative to the supporting surface 421. The first limiting part 4221 and the main control circuit board 60 may be arranged at intervals along the axial direction of the main speaker 410. The side of the support plate 510 away from the main control circuit board 60 may abut against the first limiting part 4221.

In some embodiments, as shown in FIG. 5 to FIG. 8, a pressing block 70 may be disposed between the main control circuit board 60 and the support plate 510. The pressing block 70 is configured to elastically abut against a first plate edge 511 of the support plate 510 facing toward the main control circuit board 60, so that a second plate edge 512 of the support plate 510 away from the main control circuit board 60 is supported by the first limiting part 4221.

In some embodiments, the pressing block 70 may be an elastic element, such as a spring or a foam block. The pressing block 70 may be fixedly connected to the main control circuit board 60 by adhesion, screwing, sealing connection, etc. The first plate edge 511 of the support plate 510 is pressed against an end of the pressing block 70 away from the main control circuit board 60, so that the pressing block 70 limits the support plate 510 in a direction opposite to the first direction C. The provision of the elastic pressing block 70 facilitates the flexible installation of the support plate 510 and the button assembly 50 on the acoustic cavity bracket 420, reducing the assembly difficulty of the support plate 510 and the requirement for assembly precision.

The pressing block 70 and the first limiting part 4221 may be arranged at intervals along the first direction C. The pressing block 70 and the first limiting part 4221 act together on the support plate 510 to limit the support plate 510 in the first direction C and the direction opposite to the first direction C, so that the support plate 510 is less likely to slid along the first direction C and the opposite direction and detach from the supporting surface 421, thereby fixing the button assembly 50 in the first direction C and the opposite direction of the first direction C, improving the structural stability inside the core housing 30 and avoiding poor triggering.

In some embodiments, as shown in FIG. 7, the limiting mechanism 422 may further include a second limiting part 4222. The second limiting part 4222 may be disposed around the supporting surface 421 along a second direction. The second direction may be parallel to the supporting surface 421 and perpendicular to the first direction C. The second direction may be a direction perpendicular to the first direction C. The second limiting part 4222 may be configured to limit the support plate 510 in the second direction, to prevent the support plate 510 from sliding in the second direction and detaching from the supporting surface 421. Merely by way of example, the second direction corresponds to the angle α formed by the support plate 510 and the axial direction of the acoustic cavity bracket 420. Merely by way of example, if the angle α is equal to 0°, the second direction is the longitudinal direction X of the core housing 30. In some other embodiments, the second direction D may also be another direction inclined relative to the width direction Y. Merely by way of example, the second direction is shown by arrow D in FIG. 7. The second direction D is perpendicular to the first direction C.

Merely by way of example, the limiting mechanism includes two second limiting parts 4222, the two second limiting parts are arranged at intervals along the second direction spaced apart along the second direction D, and the support plate 510 is located between the two second limiting parts 4222. As shown in FIG. 7, the two second limiting parts 4222 may be disposed on two sides of the supporting surface 421 along the second direction D, and protrude relative to the supporting surface 421. Two ends of the support plate 510 along the second direction D respectively abut against the two second limiting parts 4222, so that the two second limiting parts 4222 can limit the support plate 510 in the second direction D.

Merely by way of example, as shown in FIG. 5 and FIG. 7, the support plate 510 may include a main body portion 513 and a hook-shaped portion 514 connected to the main body portion 513. The main body portion 513 may be supported by the supporting surface 421. The button body 520 may be disposed on the main body portion 513. The hook-shaped portion 514 may be hooked on a side of the second limiting part 4222 away from the supporting surface 421. Merely by way of example, as shown in FIG. 7, the second limiting part 4222 may be elongated and protrude from the supporting surface 421. In the second direction D, one side of the second limiting part 4222 contacts the main body portion 513 of the support plate 510, and the other side contacts the hook-shaped portion 514. Therefore, the second limiting part 4222 can limit the support plate 510 in the second direction D by blocking the main body portion 513 and the hook-shaped portion 514. This arrangement facilitates the installation of the support plate 510 on the acoustic cavity bracket 420, reduces the assembly difficulty of the support plate 510 and the acoustic cavity bracket 420, and also reduces the processing difficulty of the acoustic cavity bracket 420.

Merely by way of example, the limiting mechanism includes two second limiting parts 4222. The two second limiting parts are arranged at intervals along the second direction D. The support plate 510 is located between the two second limiting parts 4222. Meanwhile, the support plate 510 may include the main body portion 513 and the hook-shaped portion 514 connected to the main body portion 513. The main body portion 513 may be supported by the supporting surface 421. The button body 520 may be disposed on the main body portion 513. The hook-shaped portion 514 may be hooked on a side of the second limiting part 4222 away from the supporting surface 421. This arrangement can further prevent the support plate 510 and the button assembly 50 from sliding in the second direction D.

In some embodiments, as shown in FIG. 7 and FIG. 8, the limiting mechanism 422 may include a third limiting part 4223 arranged parallel to the supporting surface 421 and spaced apart from the supporting surface 421. The third limiting part 4223 is located on a side of the support plate 510 away from the supporting surface 421. The third limiting part 4223 is configured to limit the support plate 510 in a vertical direction of the supporting surface 421.

Merely by way of example, the third limiting part 4223 may be connected to the first limiting part 4221 and be perpendicular to the first limiting part 4221.

Merely by way of example, the third limiting part 4223 may extend from a top end of the first limiting part 4221 in a direction away from the first direction C. The third limiting part 4223, together with the first limiting part 4221 and the supporting surface 421, may form a mounting groove 4224. The first plate edge 511 of the support plate 510 is disposed in the mounting groove 4224. The third limiting part 4223 and the supporting surface 421 limit the support plate 510 in a direction perpendicular to the supporting surface 421, to fix the support plate 510 on the supporting surface 421, making it difficult for the support plate 510 to slide and detach along a direction perpendicular to the supporting surface 421, thereby further stabilizing the support plate 510, improving the structural compactness between the acoustic cavity bracket 420 and the support plate 510, and ensuring the triggering sensitivity of the button assembly 50.

In some embodiments, as shown in FIG. 7, the second limiting part 4222 may extend in a direction away from the first direction C to form a fixing post 4225. The fixing post 4225 is spaced apart from the supporting surface 421 in a direction perpendicular to the supporting surface 421. The hook-shaped portion 514 of the support plate 510 is hooked on the second limiting part 4222. The main control circuit board 60 includes a mounting hole 610 at a position corresponding to the fixing post 4225. The fixing post 4225 may further extend into the mounting hole 610 to achieve mutual fixation between the main control circuit board 60 and the acoustic cavity bracket 420. This configuration enables reuse of the second limiting part 4222, making the structure among the acoustic cavity bracket 420, the main control circuit board 60, and the button assembly 50 more compact, and improving space utilization of the core housing 30.

By providing the limiting mechanism 422 and the pressing block 70, degrees of freedom of the support plate 510 in the first direction C, the second direction D, and a direction perpendicular to the supporting surface 421 (which are mutually orthogonal) can be constrained. The first direction C, the second direction D, and the direction perpendicular to the supporting surface 421 are mutually orthogonal. This restriction prevents the support plate 510 from loosening or detaching from the supporting surface 421 in the first direction C, the direction opposite to the first direction C, the second direction D, and the direction perpendicular to the supporting surface 421. As a result, the button assembly 50 is fixed to the supporting surface 421 by the limiting mechanism 422, thereby improving structural compactness and firmness of the core housing 30, and avoiding triggering failures of the button assembly 50 caused by shaking of the support plate 510.

In some embodiments, as shown in FIG. 4 to FIG. 8, a button hole 380 is formed in the core housing 30. A position of the button hole 380 may correspond to a position of the button assembly 50. The button portion 310 may include a cantilever beam 311, a button cap 312, and a soft filler 313. The cantilever beam 311, the soft filler 313, and the button cap 312 may be disposed in the button hole 380. A fixed end of the cantilever beam 311 is located at a hole edge of the button hole 380 and is integrally formed with the core housing 30. A side of a free end of the cantilever beam 311 faces an interior of the core housing 30 may correspond to the button body 520 in the button assembly 50. A side of the free end of the cantilever beam 311, away from the interior of the core housing 30, connects the button cap 312. The button cap 312 may be exposed at an outer surface of the core housing 30 and be configured to be pressed by the user. When the button cap 312 is pressed by the user, the button cap 312 may further push the free end of the cantilever beam 311 to move toward the interior of the core housing 30 to trigger the button body 520, thereby transmitting a corresponding control signal to the main control circuit board 60. The soft filler 313 may be configured to fill a gap between an assembly of the cantilever beam 311 and the button cap 312, and the hole edge of the button hole 380.

In some embodiments, as shown in FIG. 8, a protrusion portion 3111 is disposed on a side of the free end of the cantilever beam 311 connected to the button cap 312. A groove 3112 is disposed in the button cap 312 at a position corresponding to the protrusion portion 3111. The protrusion portion 3111 is embedded in the groove 3112. The cantilever beam 311 fixes and limits the button cap 312 through cooperation between the protrusion portion 3111 and the groove 3112. In some embodiments, the connection between the cantilever beam 311 and the button cap 312 may also be achieved through other means, such as bonding or snap-fitting, and is not specifically limited here.

In some embodiments, the soft filler 313 may be an elastic element such as silica gel or rubber. Specifically, the soft filler 313 may be fixed to a side of the cantilever beam 311 away from the interior of the core housing 30. The setting of the soft filler 313 can prevent external impurities, such as liquid, dust, and metal particles, from easily entering the core housing 30 through the button hole 380 and damaging components inside the core housing 30, thereby further improving stability and safety inside the core housing 30.

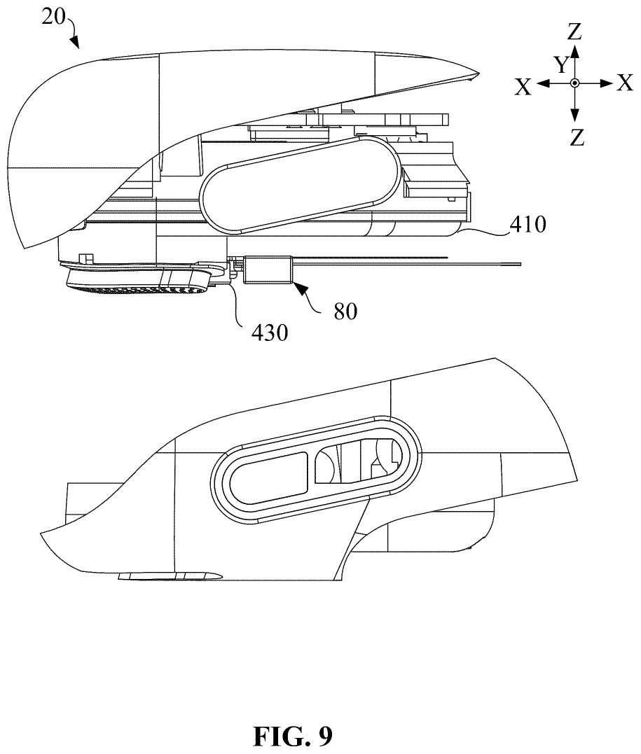

In some embodiments, as shown in FIG. 9 to FIG. 11, the earphone 1 further includes a magnet assembly 80 disposed in the core housing 30. The magnet assembly 80 has a magnetic attraction capability, so that the earphone 1 is adsorbed to a corresponding charging case or other charging device.

In some embodiments, a polarization direction of the magnet assembly 80 is the same as a polarization direction of a main magnet 413 of the main speaker 410. The main magnet 413 may be disposed in the main speaker 410. The main magnet 413 refers to a magnet element that mainly provides a magnetic field in the main speaker 410. A position of the main magnet 413 may be found in FIG. 6 and FIG. 9 and related descriptions thereof.

Setting the polarization direction of the magnet assembly 80 to be the same as the polarization direction of the main magnet 413 of the main speaker 410 enables the magnet assembly 80 and the main magnet 413 to collectively attract the earphone 1 to the corresponding charging case or other charging device. This enhances the overall magnetic attraction of the earphone 1, ensures stable adsorption of the earphone 1 to the charging case or other charging device, and ensures a charging effect.

In some embodiments, as shown in FIG. 9 to FIG. 11, the speaker assembly 40 may further include an auxiliary speaker 430. The magnet assembly 80 and the auxiliary speaker 430 may be disposed on a side of the main speaker 410 close to the auricle 103 of the user in the wearing state along the vibration direction of the main speaker 410. In other words, in the thickness direction Z, the magnet assembly 80 and the auxiliary speaker 430 are stacked with the main speaker 410, respectively.

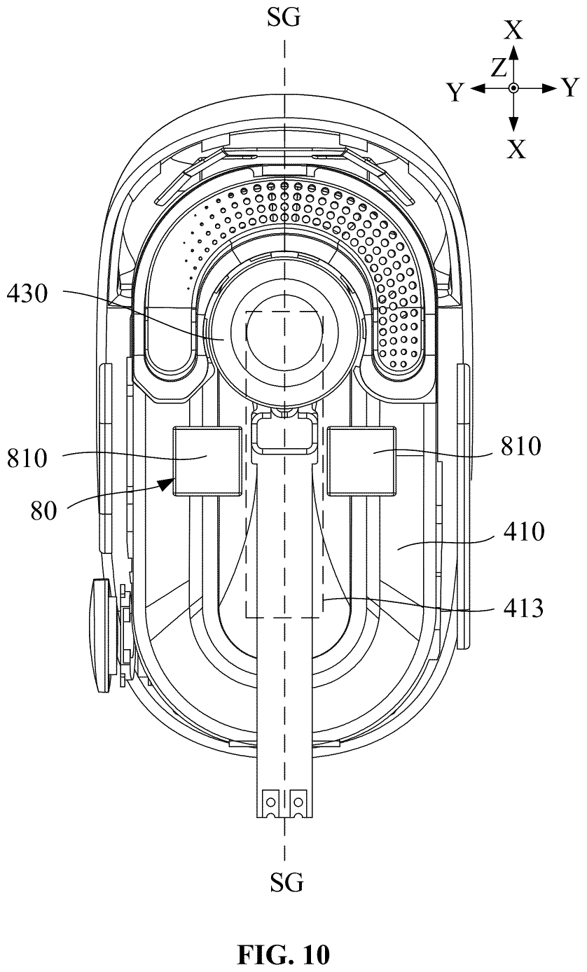

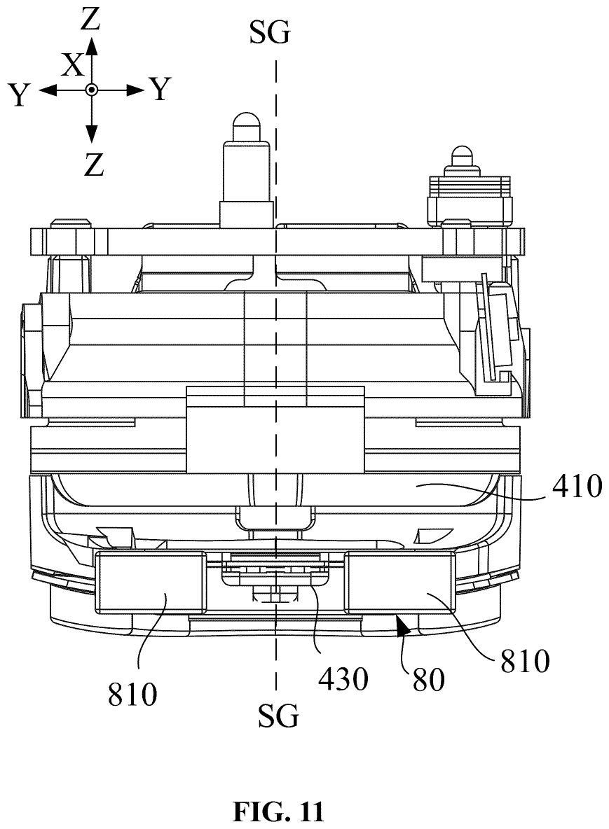

In some embodiments, with reference to FIG. 9, FIG. 10, and FIG. 11, when viewed along the longitudinal direction X of the core housing 30, the magnet assembly 80 and the auxiliary speaker 430 at least partially overlap. In other words, a projection of the magnet assembly 80 on a reference plane perpendicular to the longitudinal direction X at least partially overlaps a projection of the auxiliary speaker 430 on the reference plane perpendicular to the longitudinal direction X. This configuration improves the space utilization of the core housing 30 and ensures that the dimension of the core housing 30 in the thickness direction Z is not excessively large.

In some embodiments, a ratio of a projection area of the magnet assembly 80 along the thickness direction Z of the core housing 30 to a projection area of the main magnet 413 of the main speaker 410 along the thickness direction Z may be in a range of 0.1 to 0.2.

If the ratio of the projection area of the magnet assembly 80 along the thickness direction Z of the core housing 30 to the projection area of the main magnet 413 along the thickness direction Z is less than 0.1, it indicates that the magnet assembly 80 has a small area and cannot provide sufficient magnetic attraction to stably adsorb the earphone 1 to the charging case or other charging device. If the ratio of the projection area of the magnet assembly 80 along the thickness direction Z of the core housing 30 to the projection area of the main magnet 413 along the thickness direction Z is greater than 0.2, it indicates that the magnet assembly 80 is large. In this case, the magnetic field formed by the magnet assembly 80 is relatively strong. Since the polarization direction of the magnet assembly 80 is the same as the polarization direction of the main magnet 413, an excessively strong magnetic field of the magnet assembly 80 significantly affects the magnetic field of the main magnet 413, affecting the sound quality of the main speaker 410.

Therefore, setting the ratio of the projection area of the magnet assembly 80 along the thickness direction Z of the core housing 30 to the projection area of the main magnet 413 along the thickness direction Z in the range of 0.1 to 0.2 enables the magnet assembly 80 to have sufficient magnetic attraction to enhance magnetic attraction of the earphone 1 for adsorption to the charging case or other charging device. Moreover, when the polarization direction of the magnet assembly 80 is the same as the polarization direction of the main magnet 413, the magnet assembly 80 does not significantly affect the magnetic field of the main magnet 413, thereby ensuring sound quality of the main speaker 410.

Merely by way of example, the ratio of the projection area of the magnet assembly 80 along the thickness direction Z of the core housing 30 to the projection area of the main magnet 413 along the thickness direction Z is 0.1, 0.13, 0.16, 0.18, and 0.2.

In some embodiments, as shown in FIG. 10 and FIG. 11, the vibration direction of the main speaker 410 and the longitudinal direction X may define a symmetry plane SG. The symmetry plane SG of the main speaker 410 is also a symmetry plane SG of the main magnet 413.

In some embodiments, as shown in FIG. 10 and FIG. 11, the magnet assembly 80 may include two magnets 810. The two magnets 810 are located on two sides of the symmetry plane SG and are symmetrically arranged relative to the symmetry plane SG. The magnet 810 is an element that has magnetic attraction. For example, the magnet 810 may be an artificial magnet or a natural magnet.

Specifically, the two magnets 810 are symmetrically arranged along the symmetry plane SG to balance the magnetic field of the main magnet 413. This reduces total magnetic field deviation caused by a single magnet 810, which causes non-linearity of the magnetic field of the main magnet 413, resulting in distortion of the main speaker 410 and affecting the sound quality of the earphone 1.

In summary, the earphone 1 of the present disclosure includes the main speaker 410, the acoustic cavity bracket 420, and the button assembly 50. The acoustic cavity bracket 420 cooperates with the main speaker 410 to form the acoustic rear cavity 401, thereby ensuring the sound pickup effect of the main speaker 410. Meanwhile, the acoustic cavity bracket 420 supports the button assembly 50, thereby enabling functional reuse of the acoustic cavity bracket 420. Additionally, there is no need to provide an additional support component to support and fix the button assembly 50, thereby saving internal space of the earphone 1, reducing the size of the earphone 1, and improving space utilization.

The foregoing embodiments are merely used to illustrate the technical solutions of the present disclosure, and are not intended to limit the present disclosure. Although the present disclosure is described in detail with reference to the foregoing embodiments, persons of ordinary skill in the art should understand that they may still make modifications to the technical solutions described in the foregoing embodiments or make equivalent replacements to some technical features thereof. These modifications or replacements do not make the essence of the corresponding technical solutions depart from the spirit and scope of the technical solutions of the embodiments of the present disclosure.

1. An earphone, comprising:
a core housing; and
a speaker assembly and a button assembly disposed in the core housing,
wherein the speaker assembly includes a main speaker and an acoustic cavity bracket, the acoustic cavity bracket is arranged around and cooperates with the main speaker to form an acoustic rear cavity, the button assembly is supported by the acoustic cavity bracket, and the core housing is provided with a button portion for pressing to trigger the button assembly.

2. The earphone according to claim 1, further comprising a main control circuit board,
wherein the main control circuit board is stacked with the speaker assembly along a vibration direction of the main speaker, and a main surface of the main control circuit board is arranged to face toward or away from the speaker assembly, and the button assembly is supported by an outer circumferential surface of the acoustic cavity bracket and is electrically connected to the main control circuit board.

3. The earphone according to claim 2, wherein the button assembly includes a support plate and a button body disposed on a side of the support plate away from the acoustic cavity bracket, the button body is fixedly connected to the support plate, the support plate is fixedly supported by the outer circumferential surface of the acoustic cavity bracket, and an angle between a main surface of the support plate away from the acoustic cavity bracket and an axial direction of the acoustic cavity bracket is in a range of 0° to 10°.

4. The earphone according to claim 3, wherein the main surface of the support plate away from the acoustic cavity bracket is arranged perpendicular to the main surface of the main control circuit board facing toward or away from the speaker assembly, or an angle between the main surface of the support plate and the main surface of the main control circuit board is in a range of 80° to 90°.

5. The earphone according to claim 3, wherein a supporting surface is provided on the outer circumferential surface of the acoustic cavity bracket, a side of the support plate facing toward the acoustic cavity bracket is supported by the supporting surface, and a limiting mechanism for limiting the support plate is further provided on the acoustic cavity bracket.

6. The earphone according to claim 5, wherein the limiting mechanism includes a first limiting part disposed on a side of the supporting surface away from the main control circuit board, the first limiting part is configured to limit the support plate in a first direction, and the first direction is a direction parallel to the supporting surface and away from the main control circuit board.

7. The earphone according to claim 6, wherein a pressing block is disposed between the main control circuit board and the support plate, the pressing block is configured to elastically abut against a first plate edge of the support plate facing toward the main control circuit board, so that a second plate edge of the support plate away from the main control circuit board is supported by the first limiting part.

8. The earphone according to claim 6, wherein the limiting mechanism includes a second limiting part, the second limiting part is disposed around the supporting surface along a second direction, the second direction is parallel to the supporting surface and perpendicular to the first direction, and the second limiting part is configured to limit the support plate in the second direction.

9. The earphone according to claim 8, wherein the limiting mechanism includes two second limiting parts, the two second limiting parts are arranged at intervals along the second direction, and the support plate is located between the two second limiting parts, or
the support plate includes a main body portion and a hook-shaped portion connected to the main body portion, the main body portion is supported by the supporting surface, and the hook-shaped portion is hooked on a side of the second limiting part away from the supporting surface.

10. The earphone according to claim 8, wherein the limiting mechanism includes a third limiting part arranged parallel to the supporting surface and spaced apart from the supporting surface, the third limiting part is located on a side of the support plate away from the supporting surface, and the third limiting part is configured to limit the support plate in a vertical direction of the supporting surface.

11. The earphone according to claim 1, wherein a button hole is formed in the core housing, the button portion includes a cantilever beam, a button cap, and a soft filler, the cantilever beam, the soft filler, and the button cap are disposed in the button hole, the cantilever beam is integrally formed with the core housing, a fixed end of the cantilever beam is located at a hole edge of the button hole, the button cap is disposed at a free end of the cantilever beam, and the soft filler is configured to fill a gap between an assembly of the cantilever beam and the button cap, and the hole edge of the button hole.

12. The earphone according to claim 11, further comprising an ear hook, wherein the core housing has a connection end connected to the ear hook and a free end away from the connection end,
in a wearing state, the ear hook is hooked between an auricle and the head of a user, the core housing is located at a front side of the auricle, the free end at least partially covers or extends into a cavum conchae, the core housing has a longitudinal direction, a thickness direction, and a width direction that are orthogonal to each other, the longitudinal direction is a separation direction between the connection end and the free end, the thickness direction is a direction toward or away from the auricle in the wearing state, the core housing includes a first side wall and a second side wall arranged along the width direction, and the button portion is disposed on the first side wall or the second side wall.

13. The earphone according to claim 1, further comprising an ear hook and a magnet assembly, wherein the core housing has a connection end connected to the ear hook and a free end away from the connection end, a polarization direction of the magnet assembly is the same as a polarization direction of a main magnet of the main speaker;
the speaker assembly further includes an auxiliary speaker, the magnet assembly and the auxiliary speaker are disposed along a vibration direction of the main speaker on a side of the main speaker close to an auricle of a user in a wearing state, and when viewed along a longitudinal direction of the core housing, the magnet assembly and the auxiliary speaker at least partially overlap, and the longitudinal direction is a separation direction between the connection end and the free end.

14. The earphone according to claim 13, wherein a ratio of a projection area of the magnet assembly along a thickness direction of the core housing to a projection area of the main magnet of the main speaker along the thickness direction is in a range of 0.1 to 0.2, the thickness direction of the core housing is a direction of the core housing toward or away from the auricle of the user in the wearing state, and the thickness direction and the longitudinal direction are orthogonal to each other.

15. The earphone according to claim 13, wherein the vibration direction of the main speaker and the longitudinal direction define a symmetry plane, the magnet assembly includes two magnets, and the two magnets are located on two sides of the symmetry plane and are symmetrically arranged relative to the symmetry plane.
